(19) United States
(12) Patent Application Publication
(10) Pub. No.: US 2013/0137578 A1
(43) Pub. Date: May 30, 2013

(54) STABLE SUSPOEMULSIONS COMPRISING A PLURALITY OF AGRICULTURALLY ACTIVE INGREDIENTS

(71) Applicant: Dow Agrosciences LLC, Indianapolis, IN (US)

(72) Inventors: Wen Xu, Cary, NC (US); Holger Tank, Zionsville, IN (US); Joey D. Cobb, Noblesville, IN (US); Franklin N. Keeney, Carmel, IN (US)

(73) Assignee: Dow Agrosciences LLC, Indianapolis, IN (US)

(21) Appl. No.: 13/686,238

(22) Filed: Nov. 27, 2012

Related U.S. Application Data
(60) Provisional application No. 61/565,245, filed on Nov. 30, 2011.

(51) Int. Cl. A01N 25/04

(52) U.S. Cl. CPC A01N 25/04
USPC 504/241; 424/405; 504/255; 504/311; 504/363

(57) ABSTRACT

The present invention relates to a stable suspoemulsion which includes an oil-in-water miniemulsion which includes at least one agriculturally active ingredient and a suspension that includes at least one agriculturally active ingredient and methods of using such suspoemulsions to treat plants. The miniemulsion comprises oily globules that include at least one agriculturally active ingredient, and are coated with a polymeric adsorption layer. The polymeric adsorption layer coating the oily globules includes (1) at least one polymeric surface-active agent having an HLB values in the range of about 16 to about 18, and (2) at least one ionic surface-active agent. The oily globules of the miniemulsion have a mean particle diameter of less than about 800 nanometers, are resistant to Ostwald ripening and are well suited for the treatment of plants. Agriculturally active ingredients that can be used with the suspoemulsion include pesticides, herbicides, fungicides, mitocides, bactericides and the like.

### PRIORITY CLAIM

This application claims the benefit of U.S. Provisional Patent Application No. 61/565,245 filed on Nov. 30, 2011, this provisional patent application is incorporated herein by reference in its entirety.

### FIELD OF THE INVENTION

The present invention relates to stable suspoemulsions that include two or more agriculturally active ingredients.

### BACKGROUND

A number of factors including the globalization of both agriculturally important crops and the pests that attack them as well as increased application costs, have fueled the need for broad spectrum pesticidal formulations. Formulations that exhibit broad spectrum activity are very useful because they can be used to reduce the number of times that a particular field must be treated. And as each application invariable requires man-hours, machinery, and fuel, reducing the number of times that a given field must be treated can result in a significant cost savings. Unfortunately, very few single agriculturally active ingredients have broad spectrum activity and not all agriculturally active ingredients can be readily mixed with one another. Accordingly, there is a need for formulations that can enable stable, same tank combinations of previously difficult or impossible to co-mingle agriculturally active ingredients. Some aspects of the instant invention address this need.

### SUMMARY

Some embodiments of the invention include stable formulations of suspoemulsions comprising a suspension that includes at least one agriculturally active ingredient and a miniemulsion comprising an oil-in-water emulsion composition having at least one agriculturally active compound. in some embodiments, the oil-in-water emulsion includes:

A) an oil phase, wherein the oil phase includes at least one agriculturally active ingredient and is comprised essentially of oily globules, the oily globules having a mean particle diameter of less than about 800 nanometers; and B) an aqueous phase, wherein the oily globules are dispersed in the aqueous phase and wherein at least some of the oily globules dispersed in the aqueous phase are coated with a polymeric adsorption layer, wherein said polymeric adsorption layer comprises: (1) at least one polymeric surface-active agent having an HLB value in the range of about 16 to about 18; and (2) at least one ionic surface-active agent. In some embodiments the aqueous phase includes a second polymeric surface active agent having an HLB in the range of about 12 to about 14. In some embodiments the polymeric surface-active agent is selected from the group consisting of: amphipathic block and graft copolymers.

Amphiphatic block copolymers are linear polymeric molecules consisting of alternating hydrophobic and hydrophilic groups. Examples of those are ethylene oxide (EO)/propylene oxide (PO) block copolymers of the type EO-PO or EO-PO-EO. Graft copolymers consist of a main polymeric backbone chain which has attached to it at various points side chains which are different to the groups or units in the backbone chain. The backbone chain can be derived from a single monomer or be a copolymer derived from two or more different monomers. An example of a graft copolymer consists of a poly(methyl methacrylate) backbone with grafted polyethylene oxide side chains.

In some embodiments the aqueous phase of the miniemulsion includes a non-ionic, non-polymeric surface active agent. In some embodiments the ionic surface-active agent in the composition is selected from the group consisting of: (a) neutralized anionic surface-active agents, (b) amphoteric surface-active agents, (c) alkylsulphonic derivatives and (d) cationic surface-active agents.

In some embodiments the ionic surface-active agent in the miniemulsion is selected from the group consisting of: alkali metal salts of dicetyl phosphate and dimyristyl phosphate, in particular sodium and potassium salts; alkali metal salts of cholesteryl sulphate and cholesteryl phosphate, especially the sodium salts; lipoamino acids and their salts, such as mono- and disodium acylglutamates, such as the disodium salt of N-stearoyl-L-glutamic acid, the sodium salts of phosphatidic acid; phospholipids; the mono- and disodium salts of acylglutamic acids, in particular N-stearoylglutamic acid; and alkyl ether citrates. In some embodiments the ionic surface-active agent is a phospholipid. In some embodiments the ionic surface-active agent is an alkylsulphonic derivative. And in some embodiments the ionic surface-active agent is selected from the group consisting of quaternary ammonium salts, fatty amines, and salts thereof.

In some embodiments of the invention the amount of the polymeric surface-active agents (1) in the miniemulsion composition is in the range of about 30 to about 95 wt. % (weigth percent) of the total of both (1) and (2). In still other embodiments of the invention the amount of the polymeric surface-active agents (1) in the miniemulsion composition is in the range of about 50 to about 95, st. % of the total of both (1) and (2). And in still other embodiments of the invention the amount of the ionic surface active agent (2) in the composition is in the range of about 5 to about 50 wt. % of the total combined weight of (1) and (2).

In some embodiments of the invention the amount of the ionic surface active agent (2) in the miniemulsion is in the range of about 10 to about 50 wt. % of the total combined weight of (1) and (2).

In some embodiments of the invention the coating on the oily globules in the miniemulsion comprises between about 0.5 wt. % to about 20 wt. % based on the total weight of the oil-in-water emulsion. In still other embodiments the coating on the oily globules comprises between about 0.5 wt. % to about 10 wt. % based on the total weight of the oil-in-water emulsion. While in still other embodiments the coating on the oily globules comprises between about 0.5 wt. % to about 2.5 wt. % based on the total weight of the oil-in-water emulsion.

In some embodiments of the invention the oil-in-water miniemulsion in the composition includes at least one agriculturally active ingredient selected from the group consisting of: fungicides, insecticides, nematocides, miticides, biocides, termiticides, rodenticides, arthropodicides, herbicides, bactericides, and bacteria stats.

The suspensions included in the inventive suspoemulsions can be produced by a variety of methods including those methods used to create conventional suspensions such as the wet milling of an aqueous dispersion of solid particles.

Still other embodiments of the invention include methods of treating a plant, comprise the steps of: providing a suspoemulsion that includes an oil-in-water miniemulsion. In some embodiments these methods of treating a plant, comprising the steps of: applying an oil-in-water emulsion composition to a surface. In some embodiments the surface is the surface of a plant. While in still other embodiments the surface is adjacent to a plant. And in still other embodiments the surface is a surface of a plant, a pest, or a plant pathogen.

### BRIEF DESCRIPTION OF THE FIGURES

FIG. 1. Graph of percent (%) volume versus particle size (μm) of a cyhalofop-butyl miniemulsion.

FIG. 2. Graph of percent (%) volume versus particle size (μm) of a penoxsulam conventional suspension (SC).

FIG. 3. Graph of percent (%) volume versus particle size (μm) of a suspoemulsion comprising a cyhalofop-butyl miniemulsion and a penoxsulam suspension determined at three time points.

### DESCRIPTION

For the purposes of promoting an understanding of the principles of the novel technology, reference will now be made to the preferred embodiments thereof, and specific language will be used to describe the same. It will nevertheless be understood that no limitation of the scope of the novel technology is thereby intended, such alterations, modifications, and further applications of the principles of the novel technology being contemplated as would normally occur to one skilled in the art to which the novel technology relates are within the scope of this disclosure and the claims.

Unless stated otherwise the term, ‘about’ as used herein means plus or minus 20 percent, e.g. about 2.0 includes values between 1.6 and 2.4.

Suspensions of agriculturally active ingredients are widely used in agriculture. A suspension is a heterogeneous mixture containing solid particles that are dispersed or suspended in a continuous liquid phase. Methods for making such suspensions include wet milling of solid agriculturally active ingredients with a bead mill to create particulates with a size distribution that can be readily suspended in a liquid media that may include polymer surfactants and agriculturally acceptable thickening agents.

Likewise emulsions, especially emulsions that include oil soluble agriculturally active ingredients, have been widely used to deliver certain agriculturally active ingredients to surfaces including those of plants or areas adjacent to plants. In an emulsion, one liquid (the dispersed phase) is dispersed in the other (the continuous phase) as discrete droplets. An oil-in-water emulsion comprises an oil phase dispersed as droplets in a continuous water phase.

Miniemulsions are a special type of emulsion where the dispersed droplets typically have a size between about 50 and 800 nanometers (nm).

Formulations referred to as suspoemulsions comprising emulsions and suspensions are also used with agriculturally active ingredients. Most commercially available suspoemulsions are multiple phase colloidal systems of solid particulate suspensions and oil-in-water emulsions having oil droplets sizes greater than 1 μm. Patents and patent applications that disclose the use of suspoemulsions to deliver agriculturally active ingredients include, WO 055714, WO 114186, WO 131227, U.S. Pat. No. 0,171,979, WO 089548, and WO 9940784, each of which is hereby incorporated by reference in its entirety as if it were incorporated by reference individually.

Suspominiemulsions are multiple phase systems of solid particulate suspensions and oil-in-water miniemulsions having oil droplets sizes between about 50 and 800 nanometers (nm). Suspominiemulsions are typically formed by combining together a suspension and a miniemulsion.

Despite their widespread use currently available suspoemulsions are not without their own problems. For example, currently available suspoemulsions are not amenable to long term storage. Changes in such formulations that limit their effective shelf-life include, but are not limited to, heteroflocculation, emulsion coalescence, creaming, settling, phase separation and the like. Some of these effects become more pronounced and therefore more problematic when the surfactants used in the oil-water and water-solid interfaces adsorb and/or desorb and interchange with one another contributing to the separation of the suspension and emulsion and/or the breakdown of the emulsion over time. Problems with the stability of conventional suspoemulsions are aggravated by freeze thaw cycles and elevated temperatures limiting their utility in the field.

Concentrated oil-in water emulsions of liquid active ingredients or active ingredients dissolved in a solvent are commonly used in agricultural compositions due to certain advantages provided over other formulation types. Emulsions are water based, contain little or no solvent, allow mixtures of active ingredients to be combined into a single formulation and are compatible with a wide range of packaging material. However, there are also several disadvantages of such agricultural emulsions, for example, they are often complex formulations which require high amounts of surface-active agents for stabilization, are generally very viscous, have a tendency for Oswald ripening of the emulsion globules and separate over time. Therefore, improvements in such emulsion formulations are needed in the agricultural field.

Several oil-in-water emulsion compositions for cosmetics and dermatological applications have been described in U.S. Pat. No. 5,658,575; U.S. Pat. No. 5,925,364; U.S. Pat. No. 5,753,241; U.S. Pat. No. 5,925,341; U.S. Pat. No. 6,066,328; U.S. Pat. No. 6,120,778; U.S. Pat. No. 6,126,948; U.S. Pat. No. 6,689,371; U.S. Pat. No. 6,419,946; U.S. Pat. No. 6,541,018; U.S. Pat. No. 6,335,022; U.S. Pat. No. 6,274,150; U.S. Pat. No. 6,375,960; U.S. Pat. No. 6,464,990; U.S. Pat. No. 6,413,527; U.S. Pat. No. 6,461,625; and U.S. Pat. No. 6,902,737; each of which is incorporated herein by reference in its entirety as if each were incorporated individually. However, although these types of emulsions have found advantageous use in personal care products, these types of emulsions have not been widely used with agriculturally active compounds, which are typically present in emulsions at much higher levels than cosmetic active ingredients. Some aspects of the present invention provide novel formulations of agriculturally active ingredients that include oil-in-water emulsions which demonstrate better stability than many currently available emulsions formulated for agricultural use. Emulsions and suspominiemulsions used in agriculture are generally exposed to much harsher condition than are those used in cosmetic or dermatological preparations. The challenging conditions encountered by agricultural preparations include, large tank mixes, exposure to temperature extremes, changes in humidity, contamination, exposure to sunlight and the like. Accordingly, the techniques and formulations used in cosmetic application for example would not be expected to prove robust enough for use in commercial agriculture.

Some aspects of the present invention include an oil-in-water miniemulsion component comprising:
A) an oil phase, which comprises oily globules comprising at least one compound which is agriculturally active; and
B) an aqueous phase;
   wherein, the oily globules are dispersed in the aqueous phase and stabilized by a polymeric adsorption layer which comprises:
(1) at least one polymeric surface-active agent having an HLB value between 16 and 18, and
(2) at least one ionic surface-active agent,
   and wherein the oily globules having a mean particle diameter of less than 800 nanometers.

Some aspects of the invention include combining the miniemulsion with suspensions of agriculturally active ingredients to form stable suspoemulsions sometime referred to herein as suspominiemulsions. The active ingredients in the miniemulsion component and the suspension component of the inventive suspoemulsion may be the same or different. Any agriculturally active ingredients that are suitable for inclusion in either the miniemulsion and/or the suspoemulsion may be used to practice the invention.

The oil phase (A) of the oil-in-water emulsion of the present invention utilizes either an agriculturally active compound which is in the form of oil, or alternatively, an agriculturally active compound dissolved or mixed in an oil, to form the oily globules. Unless explicitly stated otherwise, an oil as used herein is a liquid which is not miscible with water. In this invention, almost any oil which is compatible with the agriculturally active compound may be used in the oil-in-water emulsions of the present invention. Unless stated otherwise, the term ‘compatible’ means that the oil will dissolve or mix uniformly with the agriculturally active compound and allow for the formation of the oily globules of the oil-in-water emulsion of the present invention. Exemplary oils for this use include, but are not limited to, short-chain fatty acid triglycerides, silicone oils, petroleum fractions or hydrocarbons such as heavy aromatic naphtha solvents, light aromatic naphtha solvents, hydrotreated light petroleum distillates, paraffinic solvents, mineral oil, alkylbenzenes, paraffinic oils, and the like; vegetable oils such as soy oil, rape seed oil, coconut oil, cotton seed oil, palm oil, soybean oil, and the like; alkylated vegetable oils and alkyl esters of fatty acids such as methyloleate and the like.

Agriculturally active compounds that can be used to practice the oil-in-water miniemulsion component of the present invention include, but are not limited to oils, oil based formulations, oil soluble and/or hydrophobic compounds which exhibit at least some pesticidal or other biocidal activity; and it is understood to refer to the active compounds per se which are themselves oils or alternatively, pesticidally active compounds dissolved in an oil. Such compounds or pesticides include fungicides, insecticides, nematocides, miticides, termiticides, rodenticides, arthropodicides, herbicides, biocides and the like. Examples of such agriculturally active ingredients can be found, for example, in The Pesticide Manual, 12^{th} Edition. Exemplary pesticides which can be utilized in the oil-in-water emulsion of the present invention include, but are not limited to, benzofuranyl methylcarbamate insecticides such as benfuracarb, and carbosulfan; oxime carbamate insecticides such as aldicarb; fumigant insecticides such as chloropicrin, 1,3-dichloropropene and methyl bromide; juvenile hormone mimics such as fenoxycarb; organophosphate insecticides such as dichlorvos; aliphatic organothiophosphate insecticides such as malathion and terbufos; aliphatic amide organothiophosphate insecticides such as dimethoate; benzotriazine organothiophosphate insecticides such as azinphos-ethyl and azinphos-methyl; pyridine organothiophosphate insecticides such as chlorpyrifos and chlorpyrifos-methyl; pyrimidine organothiophosphate insecticides such as diazinon; phenyl organothiophosphate insecticides such as parathion and parathion-methyl; pyrethroid ester insecticides such as bifenthrin, cyfluthrin, beta-cyfluthrin, cyhalothrin, gamma-cyhalothrin, lambda-cyhalothrin, cypermethrin, alpha-cypermethrin, beta-cypermethrin, fenvalerate, and permethrin; and the like.

Exemplary herbicides which can be used in the oil-in-water miniemulsion of the present invention include, but are not limited to: amide herbicides such as dimethenamid and dimethenamid-P; anilide herbicides such as propanil; benzoic acid herbicides such as dicamba; chloroacetanilide herbicides such as acetochlor, alachlor, butachlor, metolachlor and S-metolachlor; cyclohexene oxime herbicides such as sethoxydim; dinitroaniline herbicides such as benfluralin, ethalfluralin, pendimethalin, and trifluralin; nitrile herbicides such as bromoxynil octanoate; phenoxyacetic herbicides such as 4-CPA, 2,4-D, 3,4-DA, MCPA, and MCPA-thioethyl; phenoxybutyric herbicides such as 4-CPB, 2,4-DB, 3,4-DB, and MCPB; phenoxypropionic herbicides such as cloprop, 4-CPP, dichlorprop, dichlorprop-P, 3,4-DP, fenoprop, mecopropand mecoprop-P; aryloxyphenoxypropionic herbicides such as cyhalofop, fluazifop, fluazifop-P, haloxyfop, haloxyfop-R; pyridine herbicides such as aminopyralid, clopyralid, fluoroxypyr, picloram, and triclopyr; triazole herbicides such as carfentrazone ethyl; and the like.

Many of the herbicides that can be used to practice the invention can also generally be employed in combination with known herbicide safeners such as: benoxacor, cloquintocet, cyometrinil, daimuron, dichlormid, dicyclonon, dietholate, fenchlorazole, fenchlorazole-ethyl, fenclorim, flurazole, fluxofenim, furilazole, isoxadifen, isoxadifen-ethyl, mefenpyr, mefenpyr-diethyl, MG191, MON4660, R29148, mephenate, naphthalic anhydride, N-phenylsulfonylbenzoic acid amides and oxabetrinil.

Active ingredients that may be used in the suspension component of the present invention have low solubility in water, preferably less than 0.1%, high melting points, preferably >80° C. and are hydrolytically stable in water.

Exemplary herbicides for use in the suspension are atrazine, bromoxynil, desmedipham, diflufenican, diuron, fomesafen, ioxynil, isoproturon, isoxaben, linuron, oryzalin, oxyfluorfen, phenmedipham, prometryn, propyzamide, penoxsulam, pyroxsulam, quinclorac, simazine, terbuthylazine, terbutryn, tralkoxydim, flumioxazin, flumetsulam, metosulam, diclosulam, cloransulam-methyl.

Exemplary fungicides for use in the suspension are azoxystrobin, benomyl, captan, carbendazim, chlorothalonil, dimethomorph, dodine, epoxiconazole, fenarimol, fenbuconazole, fluoxastrobin, iprovalicarb, kresoxim-methyl, orysastrobin, quinoxyfen, tebuconazole, thifluzamide, thiophanate-methyl, thiram, tricyclazole, zoxamide.

Exemplary insecticides for use in the suspension are carbaryl, carbofuran, deltamethrin, fipronil, halofenozide, hexaflumuron, imidacloprid, methoxyfenozide, noviflumuron, spinetoram, spinosad, sulfoxaflor, tebufenozide, thiodicarb.

Exemplary fungicides which can be used in the oil-in-water emulsion of the present invention include, but are not limited to, difenoconazole, dimethomorph, dinocap, diphenylamine, dodemorph, edifenphos, fenarimol, fenbuconazole, fenpropimorph, myclobutanil, oleic acid (fatty acids), propiconazole, tebuconazole and the like.

In one embodiment of the present invention, the suspominiemulsion may contain one or more agriculturally active ingredients that are substantially dissolved in the water phase of the suspominiemulsion.

It is understood by those skilled in the art that any combination of agriculturally active compounds may also be used in the oil-in-water emulsion of the present invention as long as a stable and effective emulsion is still obtained.

The amount of agriculturally active ingredient within the oil-in-water emulsion will vary depending upon the actual active ingredient, the application of the agriculturally active ingredient and the appropriate application levels which are well known to those skilled in the art. Typically, the total amount of agriculturally active ingredient within the oil-in-water emulsion will be from about 1, generally from about 5, preferably from about 10, more preferably from about 15 and most preferably from about 20 to about 45, generally to about 40, preferably to about 35 and most preferably to about 30 weight percent based on the total weight of the oil-in-water emulsion.

The polymeric surface-active agent in some embodiments has an HLB in the range of about 16 and about 18. The acronym HLB refers to the term “Hydrophilic Lipophilic Balance” which identifies an emulsifier's solubility in water or oil. Polymeric surface-active agents which can be used in the oil-in-water emulsion of the present invention include amphipathic block or graft copolymers. Preferred polymer surfactants are, but not limited to, EO/PO block copolymers. Block copolymers of ethylene-oxide (EO) and propylene-oxide (PO), as well as copolymers of EO and PO from ethylene diamine, are available in a variety of formulas and from a variety of sources, including the Tetronic™ and Pluronic™ polymers from BASF™, the Toximul™ polymers from Stepan™, the Atlas™ polymers from Unigema™, as well as other sources.

The following is a non-limiting description of the nonionic block copolymers that may be useful herein. Structurally, nonionic block copolymers are characterized by an EO-PO-EO arrangement. They may have a total hydrophile (EO) content of about at least 30% or higher of the total molecular weight. The hydrophilic/lipophilic balance (HLB) of the nonionic block copolymers is about 16 to 18. The molecular weight of the polymeric surfactant is usually around 2000 to 15,000, preferably around 3000 to 8,000. Examples of preferable EO-PO polymers are, but not limited to, Toximul™ 8323, Atlas™ G5000, Pluronic™ P105, and Pluronic™ P85.

In addition to the polymeric surface-active agent, an ionic surface-active agent (2) also comprises the polymeric adsorption layer that is physically adsorbed onto the outer surface of oily globule. Ionic surface-active agents which can be used in the oil-in-water emulsion of the present invention include compounds such as (a) neutralized anionic surface-active agents, (b) amphoteric surface-active agents, (c) alkylsulphonic derivatives and (d) cationic surface-active agents.

Neutralized anionic surface-active agents (a) include, but are not limited to, for example:
alkali metal salts of dicetyl phosphate and dimyristyl phosphate, in particular sodium and potassium salts;
alkali metal salts of cholesteryl sulphate and cholesteryl phosphate, especially the sodium salts;
lipoamino acids and their salts, such as mono- and disodium acylglutamates, such as the disodium salt of N-stearoyl-L-glutamic acid, the sodium salts of phosphatidic acid;
phospholipids; and
the mono- and disodium salts of acylglutamic acids, in particular N-stearoylglutamic acid.

Some anionic surface-active agents chosen from alkyl ether citrates and mixtures thereof which can be used in the oil-in-water emulsions of the present invention are disclosed in U.S. Pat. No. 6,413,527, which is incorporated herein by reference in its entirety. Alkyl ether citrates include monoesters or diesters formed by citric acid and at least one oxyethylenated fatty alcohol comprising a saturated or unsaturated, linear or branched alkyl chain having from 8 to 22 carbon atoms and comprising from 3 to 9 oxyethylene groups, and mixtures thereof. Citrates that can be used to practice the invention include those chosen from the group consisting of, mono- and diesters of citric acid and of ethoxylated lauryl alcohol comprising from 3 to 9 oxyethylene groups. The alkyl ether citrates are preferably employed in the neutralized form at a pH of about 7. Neutralization agents can be chosen from inorganic bases, such as sodium hydroxide, potassium hydroxide or ammonia, and organic bases, such as mono-, di- and triethanolamine, aminomethyl-1,3-propanediol, N-methylglucamine, basic amino acids, such as arginine and lysine and mixtures thereof.

Amphoteric surface-active agents (b) include, but are not limited to, phospholipids and especially phosphatidylethanolamine from pure soya.

Alkylsulphonic derivatives (c) include, but are not limited to compounds of the formula:

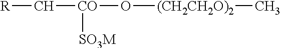

in which R represents the radicals C₁₆H₃₃ and C₁₈H₃₇, taken as a mixture or separately, and M is an alkali metal, preferably sodium.

Cationic surface-active agents (d) include, but are not limited to, surface-active agents such as those disclosed in U.S. Pat. No. 6,464,990, which is incorporated herein by reference in its entirety. They are typically selected from the group of quaternary ammonium salts, fatty amines and salts thereof. The quaternary ammonium salts include, for example, those which exhibit the following formula:

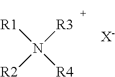

wherein the R1 to R4 radicals, which can be identical or different, represent a linear or branched aliphatic radical comprising from 1 to 30 carbon atoms or an aromatic radical, such as aryl or alkylaryl. The aliphatic radicals can comprise heteroatoms, such as oxygen, nitrogen, sulfur and halogens. The aliphatic radicals include alkyl, alkoxy, polyoxy(C₂-C₆)alkylene, alkylamido, (C₁₂-C₂₂)alkyl-amido(C₂-C₆)alkyl, (C₁₂-C₂₂)alkyl acetate and hydroxyalkyl radicals comprising approximately from 1 to 30 carbon atoms; X is an anion selected from halides, phosphates, acetates, lactates, (C₂-C₆)alkyl sulfates, and alkyl- or alkylarylsulfonates. Preference is given, as quaternary ammonium salts to tetraalkylammonium chlorides, such as dialkyldimethylammonium and alkyltrimethylammonium chlorides in which the alkyl radical comprises approximately from 12 to 22 carbon atoms, in particularly behenyltrimethyl-ammonium, distearyldimethylammonium, cetyltrimethylammonium and benzyldimethylstearylammonium chlorides, or alternatively, stearamidopropyl-dimethyl(myristyl acetate) ammonium chloride; imidazolinium quaternary ammonium salts, such as those of formula:

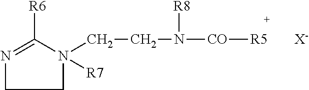

wherein R5 represents an alkenyl or alkyl radical comprising from 8 to 30 carbon atoms, for example derived from tallow fatty acids; R6 represents a hydrogen atom, an alkyl radical comprising from 1 to 4 carbon atoms or an alkenyl or alkyl radical comprising from 8 to 30 carbon atoms; R7 represents an alkyl radical comprising from 1 to 4 carbon atoms; R8 represents a hydrogen atom or an alkyl radical comprising from 1 to 4 carbon atoms; and X is an anion selected from the group of the halides, phosphates, acetates, lactates, alkyl sulfates, or alkyl, and alkylarylsulfonates. R5 and R6 preferably denote a mixture of alkenyl or alkyl radicals comprising from 12 to 21 carbon atoms, for example, derived from tallow fatty acids, R7 preferably denotes a methyl radical and R8 preferably denotes hydrogen. Quaternary diammonium salts are also contemplated, such as propanetallowediammonium dichloride.

Fatty amines include, but are not limited to those of formula:

R9(CONH)ₙ(CH₂)ₘN(R11)R10

wherein R9 is an optionally saturated and/or branched hydrocarbon chain, having between 8 and 30 carbon atoms, preferably between 10 and 24 carbon atoms; R10 and R11 are selected from H and an optionally saturated and/or branched hydrocarbon chain, having between 1 and 10 carbon atoms; preferably between 1 and 4 carbon atoms; m is an integer between 1 and 10 and is preferably between 1 and 5; and n is either 0 or 1.

Examples of fatty amines that can be used to practice the invention include, but are not limited to, stearylamine, aminoethyl-ethanolamide stearate, diethylenetriamine stearate, palmitamidopropyldimethyl-amine, palmitamidopropyldiethylamine, palmitamidoethyldiethylamine, palmitamidoethyldimethylamine. Commercially available fatty amines include, but are not limited to, Incromine™ BB from Croda, Amidoamine™ MSP from Nikkol, and Lexamine™ series from Inolex, the Acetamine series from Kao Corp; Berol 380, 390, 453 and 455, and Ethomeen™ series from Akzo Nobel, and Marlazin™ L10, OL2, OL20, T15/2, T50 from Condea Chemie.

The surface-active agents of (1) and (2) form a polymeric adsorption layer surrounding the oily globules suspended within the aqueous phase of the oil-in-water emulsion of the present invention. The amount of the surface-active agents (1) utilized in the oil-in-water emulsion of the present invention is typically from 0.1 to 20, preferably from about 0.5 to about 10, and more preferably to about 2 weight percent, based on the total weight of the oil-in-water emulsion. The amount of the surface-active agents (2) utilized in the oil-in-water emulsion of the present invention is typically from 0.1 to 20, preferably from about 0.2 to about 5, and more preferably to about 0.5 weight percent, based on the total weight of the oil-in-water emulsion.

The ratio of the total weight of the surface-active compounds (1) and (2) to the total weight of oil is typically from about 1:2.5 to about 1:30.

The aqueous phase (B) is typically water, for example, deionized water. The aqueous phase may also contain other additives such as compounds that lower the freezing point, for example, alcohols, e.g., isopropyl alcohol and propylene glycol; pH buffering agents, for example, alkali phosphates such as sodium phosphate monobasic monohydrate, sodium phosphate dibasic; biocides, for example, Proxel GXL; and antifoams, for example octamethylcyclotetrasiloxane (Antifoam A from Dow Corning). Other additives and/or adjuvants can also be present in the aqueous phase (B) as long as the stability of the oil-in-water emulsion is still maintained. Other additives also include water-soluble agriculturally active compounds.

The oil phase or the coated oily globules are typical from about 0.1 to about 55, preferably from about 10 to about 50, and more preferably from about 20 to about 45 percent, and most preferably from about 30 to about 40 weight percent, based on the total weight of the oil-in-water emulsion composition. The oil/water ratio is typically less than or equal to 1.

Other additives and/or adjutants can also be present within the oil-in-water miniemulsions of the present invention, as long as the stability and activity of the oil-in-water emulsion is not significantly reduced. Some of the oil-in-water emulsions of the present invention may include additional polymeric surface-active agents (3) to improve the performance of the emulsions such as the emulsion's stability, and its low temperature stability performance. Suitable polymer surface-active agents may include, but are not limited to, non ionic polymeric surfactants with HLB value from 12 to 14, such as Soprophor™ 796/P (Ethopropoxylated Polyarylphenol from Rhodia). Some of the oil-in-water emulsions of the present invention may additionally include adjuvant surface-active agents used to enhance properties such as deposition, wetting and penetration of the agriculturally active ingredient onto the target site, e.g., crop, weed, organism or surface-active agent to a plant. These adjuvant surface-active agents may optionally be employed as a component of the emulsion in either phase A or B, or as a tank mix component; the use of and amount desired being well known by those skilled in the art. Suitable adjuvant surface-active agents include, but are not limited to, ethoxylated nonyl phenols, ethoxylated synthetic or natural alcohols, salts of the esters or sulphosuccinic acids, ethoxylated organosilicones, ethoxylated fatty amines and blends of surface-active agents with mineral or vegetable oils.

Surfactants that can be used in the suspensions are typically described as wetting agents and dispersing agents. Examples for wetting agents are sodium dodecyl sulphate, sodium lauryl ether sulphate, cetyltrimethylammonium chloride, dimethyldodecylamine propane sulphonate, alcohol ethoxylates, alkyl phenol ethoxylates, amine oxides, and amine ethoxylates. Dispersing agents include for example poly vinyl alcohol (with poly vinyl acetate blocks), block copolymers of ethylene oxide-propylene oxide, graft copolymers, e.g. poly(methyl methacrylate) backbone with grafted polyethylene oxide chains, naphthalene formaldehyde sulphonated condensates, and lignosulphonates.

The oil-in-water miniemulsion of the present invention can be prepared, in part, according to the process described in U.S. Pat. No. 5,925,364, the teachings of which are incorporated herein by reference in its entirety. The mixture may be homogenized by cavitations using a high pressure homogenizer, to provide the small particle sized oily globules. The mean size of the coated oily globules is typically less than about 800 nanometers, preferably less than about 500 nanometers and more preferably about 200 nanometers, as determined using laser diffraction particle size analysis and scanning electron microscopy.

In one embodiment, the oil-in-water emulsion is prepared by:
1) mixing (A) an oil phase, an agriculturally active compound and optionally an oil and (B) an aqueous phase, comprising water, the polymeric surfactant(s) and the ionic surfactant(s), to obtain a mixture; and
2) homogenizing the mixture, for example, by subjecting the mixture to cavitation.

In the first step, the mixture can be formed by conventional stirring, for example, using a high shear homogenizer rotating at a rate of approximately between 2000 and 7000 rpm for a time period of between about 5 to about 15 minutes and at a temperature of between approximately 20° C. and 50° C.

The homogenization step may be performed by using a high pressure homogenizer operating at pressures between approximately 200 and 1000 bar as is well known to those skilled in the art. The process may be performed by successive passages, generally from 1 to 4 passages, at an elevated pressure; the mixture gradually being returned to normal (generally ambient) pressure between each passage. The homogenization of the second step may also be carried out using other techniques such as ultrasound or by the use of a homogenizer equipped with a rotor-stator type head.

Suspensions useful for the practice of the invention include conventional suspension that can be formed by wet milling and agriculturally active ingredient. Such suspensions are typically made using agriculturally active ingredients that have low solubility in aqueous solutions. These suspensions may also include reagents that help to stabilize such suspensions, these reagents may include surfactants such as polymer surfactants, and thickeners. Other reagents may also be added to such suspension including for example, bacteria-stats, uv blockers, other preservatives, dyes, and the like.

Examples of common thickeners used in suspensions are swelling clays such as VEEGUM Magnesium Aluminum Silicate, polysaccharides such as xanthan gum, or AVICEL microcrystalline cellulose.

Other embodiments of the present invention may include the use of the oil-in-water emulsion in agricultural applications to control, prevent or eliminate unwanted living organisms, e.g., fungi, weeds, insects, bacteria or other microorganisms and other pests. This use includes its use for protecting a plant against attack by a phytopathogenic organism or the treatment of a plant already infested by a phytopathogenic organism, comprising the step applying the oil-in-water emulsion composition, to soil, a plant, a part of a plant, foliage, flowers, fruit, and/or seeds, or any surface adjacent to a plant in a disease inhibiting and phytologically acceptable amount. The term “disease inhibiting and phytologically acceptable amount” refers to an amount of a compound that kills or inhibits the plant disease for which control is desired, in an amount not significantly toxic to the plant being treated. The exact concentration of active compound required varies with the fungal disease to be controlled, the type of formulations employed, the method of application, the particular plant species, climate conditions, and the like, as is well known in the art.

Additionally, the oil-in-water suspoemulsions of the present invention are useful for the control of insects or other pests, e.g., rodents. Therefore, the present invention provides methods for inhibiting insects or other pest, such as ticks and mites. These methods comprise the step of contacting a pest or an area adjacent to pest or “locus” with a suspoemulsion that includes an agriculturally effective amount of a pest-inhibitor or pesticide. The “locus” of insects or pests is a term used herein to refer to the environment in which the insects or other pests live or where their eggs are present, including the air surrounding them, the food they eat, or surfaces which they contact. For example, insects which eat or contact crop plants or other desirable plants can be controlled by applying the active compound to plant parts such as the seed, seedling, or cutting which is planted, the leaves, stems, fruits, grain, or roots, to the soil in which the roots are growing or to any surfaces adjacent to the desirable plants. It is contemplated that the agriculturally active compounds and oil-in-water emulsions containing such might also be useful to protect textiles, paper, stored grain, seeds, domesticated animals, buildings or human beings by applying an active compound to or near such objects. The term “inhibiting an insect or pest” refers to a decrease in the numbers of living insects or other pests in any stage of their life cycle, or a decrease in the number of viable insect or other pest eggs. The extent of reduction accomplished by a compound depends, of course, upon factors including the application rate of the compound, the particular compound used, and the target insect or pest species and the like. At least an inactivating amount should be used in at least one application of the material. The terms “insect or pest-inactivating amount” are used to describe the amount, which is sufficient to cause a measurable reduction in the treated insect or pest population, as is well known in the art.

The locus to which a compound or composition is applied can be any locus inhabited by an insect, mite or pest, for example, vegetable crops, fruit and nut trees, grape vines, ornamental plants, domesticated animals, plants grown for fuel, wood or fiber, the interior or exterior surfaces of buildings, and the soil around buildings.

Because of the unique ability of insect eggs and other pest lain eggs to resist toxicant action, as is true of many insecticides and acaricides, repeated applications may be desirable to control newly emerged larvae.

Additionally, the present invention relates to the use of oil-in-water emulsions comprising agriculturally active compounds which are herbicides. Unless explicitly stated otherwise or clearly intended otherwise the term herbicide is used herein to mean an active ingredient that kills, controls or otherwise adversely modifies the growth of at least one type of plant. An herbicidally effective or vegetation controlling amount of an herbicide is an amount of active ingredient which causes an adversely modifying effect and includes deviations from natural development of the plant, killing, regulation, desiccation, retardation, and the like. The terms “plants” and “vegetation” include emerging seedlings as well as established and dormant vegetation.

Herbicidal activity may be exhibited when the compound(s) are applied directly to the locus of an undesirable plant thereof at any stage of growth or before emergence of the weeds. The effect observed depends upon factors such as the plant species to be controlled, the stage of growth of the plant, the particle size of solid components, the environmental conditions at the time of use, the specific adjuvants and carriers employed, the soil type, and the like, as well as the amount of chemical applied. These and other factors can be adjusted, as is known in the art, to promote selective herbicidal action. Generally, it is preferred to apply such herbicides post emergence or to relatively immature undesirable vegetation to achieve the maximum control of weeds.

Still other aspects of the present invention include methods of preventing or controlling pests such as nematodes, mites, arthropods, rodents, termites, bacteria or other microorganisms, comprising applying to a locus where control or prevention is desired a composition of the present invention which comprises the appropriate active compound such as a nematocide, miticide, arthropodicide, rodenticide, termiticide or biocide.

The actual amount of agriculturally active compound to be applied to loci of disease, insects and mites, weeds or other pests is well known in the art and can readily be determined by those skilled in the art in view of the teachings above.

The composition of the present invention surprisingly offers stable agricultural oil-in-water emulsions having low viscosity and long term shelf life. Additionally, the stable agricultural oil-in-water emulsions of the present invention can offer other surprising improvements, e.g., efficacy.

A typical mixture includes: surfactant micelles (depicted as 6-armed star shaped icons); surfactant monomers (depicted as short dark rods); emulsion droplets (depicted as open circles bordered by a spiked thick wall); soli particles (depicted as open circles surrounded by a thin regular circular wall); and an aqueous phase.

The following examples are provided to illustrate the present invention. The examples are not intended to limit the scope of the present invention and they should not be so interpreted. Amounts are in weight parts or weight percentages unless otherwise indicated.

### EXAMPLES

The following examples are provided to further illustrate the invention and are not meant to be construed as limiting.

As disclosed herein, all temperatures are given in degrees Celsius and all percentages given for reagent formulation are weight percentages unless otherwise stated.

### Example 1

The miniemulsions of the example may be created according to the following procedure:

Oil phase A and the aqueous phase B may be heated separately to their desired temperatures. Phase B is poured into Phase A, with stirring of 3000-7000 rpm provided by a Silverson L4RT high shear homogenizer fitted with a square hole high shear screen. Stirring and temperature conditions are maintained for about 5 to about 15 minutes.

The mixture is then introduced into a Niro Soavi high pressure 2-stage homogenizer of type Panda 2K, which is adjusted to a pressure of about 500 to about 1000 bar for 1 to 4 successive passages.

The homogenizer steps are carried out as necessary to form an oil-in-water cyhalofop-butyl miniemulsion. The oily globules of the miniemulsion have a mean diameter of less than 600 nm and preferable of about 200 nm (0.2 μm). The reagents comprising the miniemulsion in the example are listed in Table 1.

A suspension of penoxsulam is formed by wet-milling penoxsulam in an aqueous milieu that includes the reagents and compounds listed in Table 1.

The stable suspominiemulsion is then created by mixing the cyhalofop-butyl miniemulsion with the penoxsulam suspension in the presence of the additional reagents included in Table 1.

TABLE 1
Reagents and compounds used to create a stable exemplary
suspominiemulsion comprising a miniemulsion of cyhalofop-
butyl and a suspension of penoxsulam.

| | |
|---|---|
| | Aim Concen- |
| Role | tration (%) |

Miniemulsion Oil Phase

| | | |
|---|---|---|
| Cyhalofop-butyl | Active Ingredient | 28 |
| Aromatic 150 ND | Solvent | 21.7 |
| Soybean Oil | Co-solvent | 4 |

Miniemulsion Aqueous Phase

| | | |
|---|---|---|
| Cedepol TD-407 | Anionic Surfactant | .63 |
| Toximul 8323 | Polymeric | 2 |
| | Surfactant | |
| | (HLB 17.0) | |
| Soprophor 796P | Polymeric | 0.5 |
| | Surfactant | |
| | (HLB 14.0) | |
| Proxel GXL | Biocide | 0.1 |
| Propylene Glycol | Antifreeze | 6 |
| Water | Continuous phase | 37.07 |

GF-881 Penoxsulam suspension

| | | |
|---|---|---|
| Penoxsulam | Active Ingredient | 50 |
| Antifoam B | Antifoam | 0.5 |
| Avicel CL-611 | Rheology Modifier | 0.5 |
| Citric acid | Acidifier | 0.2 |
| Kelzan | Rheology Modifier | 0.1 |
| Morwet D-425 | Dispersant | 4 |
| Pluronic P-105 | Dispersant | 1 |
| Propylene glycol | Antifreeze | 3 |
| Proxel GXL | Biocide | 0.1 |
| Water | Continuous phase | 40.6 |

Suspominiemulsion

| | | |
|---|---|---|
| Cyhalofop-butyl | | 85.77 |
| miniemulsion | | |
| Penoxsulam suspension | | 5.83 |
| (GF-881) | | |
| Morwet D-425 | Dispersant | 1.00 |
| Pluronic P-105 | Dispersant | 0.13 |
| Kelzan | Rheology Modifier | 0.1 |
| Water | Continuous phase | 7.17 |

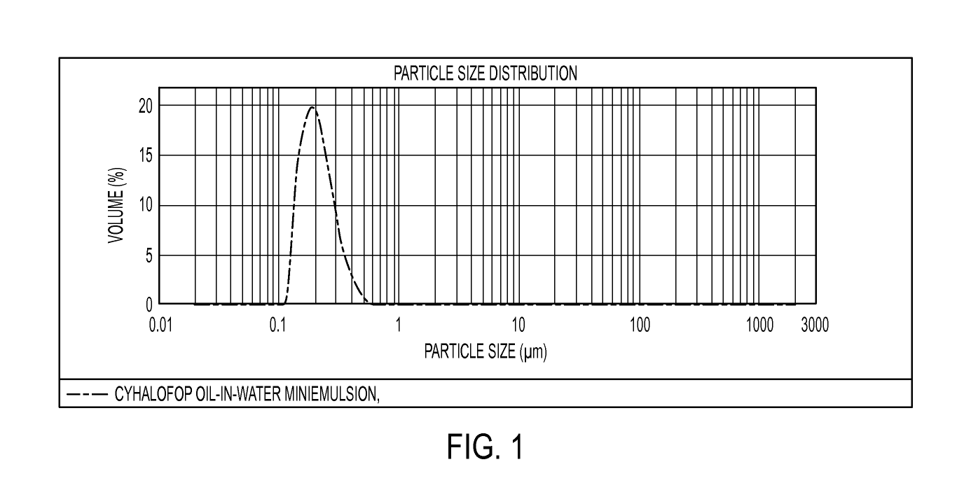

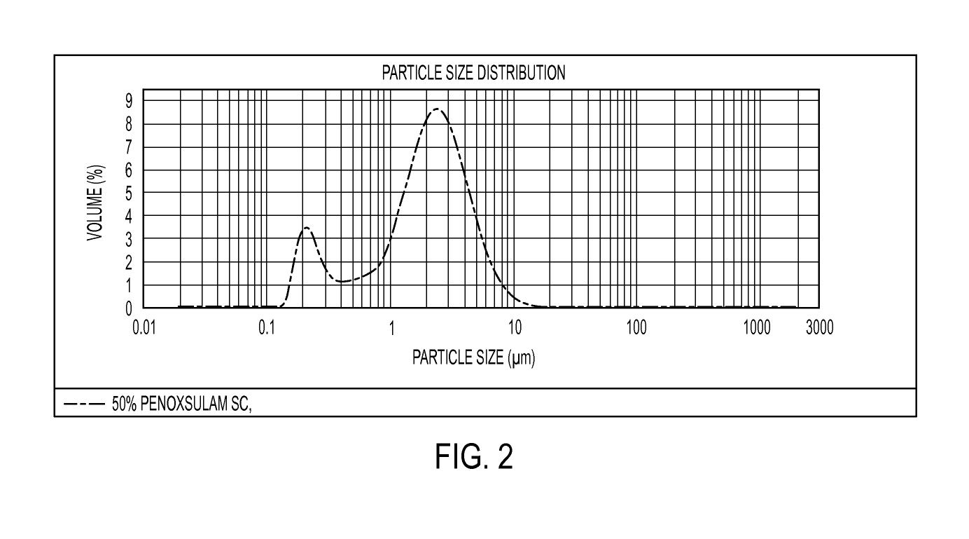

Referring now to FIG. 1, this figure shows the particle size distribution for the cyhalofop-butyl miniemulsion formed using the ingredients enumerated in Table 1. The results of the determination are shown in the graph of volume (%) versus particle size expressed in μm. The particle sizes in the exemplary miniemulsion exhibit a Gaussian distribution; the median diameter of the particle is about 0.2 μm. Referring now to FIG. 2, this figure shows the particle size distribution for the penoxsulam suspension (SC) formed using the ingredients enumerated in Table 1. The results of the determination are shown in the graph of volume (%) versus particle size expressed in μm. The particles in the suspension form a bimodal distribution with a median diameter of 2.05 μm. The particles fall within two not totally resolved peaks the mean particle size for the smaller peak is about 0.2 μm while the mean for the much larger peak is about 2.5 μm.

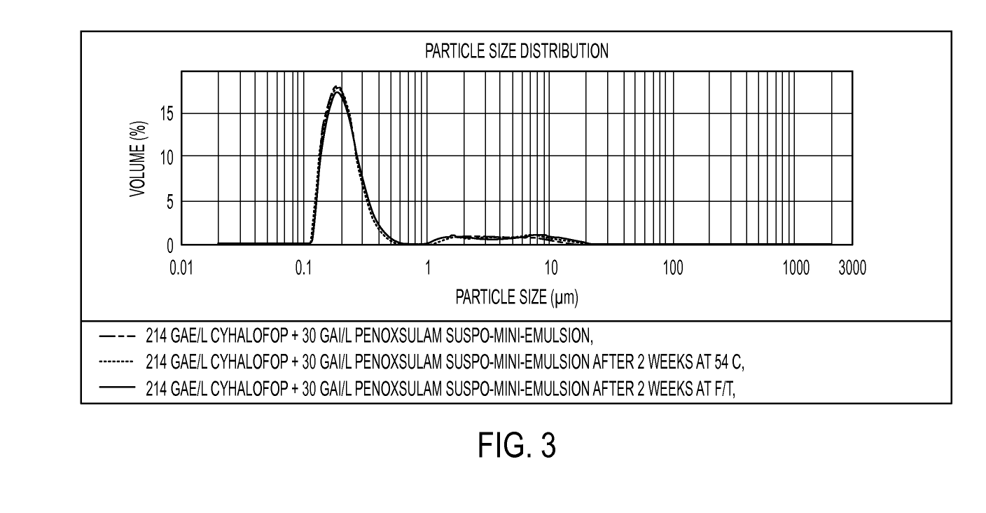

Referring now to FIG. 3, this figure shows the particle size distribution for the suspoemulsion according to Table 1, formed by mixing the cyhalofop-butyl miniemulsion with the penoxsulam suspension (SC). The results of the determination are shown in the graph of volume (%) versus particle size expressed in μm. The particles in the suspoemulsion cluster in two distinct ranges. Particles comprising the largest volume cluster in a Gaussian manner around a mean size of about 0.2 μm in conformity with what is observed with the particle distribution of the cyhalofop-butyl miniemulsion. Referring again to FIG. 3, the said particle distribution resembles that found in FIG. 2 for the penoxsulam suspension.

Still referring to FIG. 3, the distribution of particles in the exemplary suspominiemulsion was followed for two weeks. Accordingly, FIG. 3 includes three traces one of the measurements is soon after the suspominiemulsion was first made; while the other two traces are of the same suspominiemulsion examined after 2 weeks stored at 54° C. or after 2 weeks storage under a freeze thaw cycle. All 3 traces are virtually identical demonstrating the unexpected stability of the inventive suspominiemulsion.

### Forming Miniemulsions

84 g of cyhalofop-butyl were dissolved in a blend of 65.1 g Aromatic 150 ND Solvent and 12.0 g soybean oil. The oil phase was added to the aqueous phase consisting of 111.21 g water, 1.89 g Cedepol TD 407, 6.00 g Toximul 8323, 1.50 g Soprophor 796P, 0.30 g Proxel GXL and 18.00 g propylene glycol under high shear agitation using a Silverson L4R laboratory homogenizer with a square hole high shear screen. Stirring was maintained for 10 minutes. The mixture was then introduced into a Nitro Soavi high pressure 2-stage homogenizer of the type Panda 2K, which is adjusted to a pressure of 500 bar for 3 successive passages.

This method formula stabilize oil-in-water miniemulsion, the oily globules of the miniemulsion have a mean diameter d(0.5) of about 204 nm.

### Alternative Methods for Forming Miniemulsions

The homogenization process of the second step may also be carried out under the action of ultrasound or alternatively by the use of a homogenizer equipped with a rotor-stator type head.

### Forming an Exemplary Suspension

The suspension containing 50% of penoxsulan was prepared as follows: 500 g penoxsulam was disperesed in an aqueous phase containing 406 g water, 40 g Morwet D-425, 10 g Pluronic P-105, 2 g citric acid, 1 g Proxel GXL, 5 g Antifoam B and 5 g Avicel CL-611 using a Silverson L4R laboratory homogenizer with a square hole high shear screen. After the active ingredient appeared to be completely dispersed, the suspension was milled using an Eiger mill Model M250 filled to 80% capacity with 1.25-1.55 mm glass beads. Two passes through the mill were sufficient to achieve the desired particle size, i.e., particle with an average median diameter d(0.5) of about 2.05 μm and a d(0.9) of about 4.75 μm. After the milling process was completed, 1 g of Kelzan dispersed in 30 g of propylene glycol was added to the milled suspension under stirring, agitation was continued for 30 minutes until the Kelzan appeared to be fully hydrated.

### Alternative Methods of Forming Suspensions

The method described above is likely to be the most common method for making suspension concentrates. Alternatively, one could mill the active ingredient using a dry milling process, i.e. air jet milling, and dispersing the milled active ingredient in the aqueous phase without further wet milling.

### Exemplary Suspoemulsions (Suspominiemulsions)

3.0 g of Morwet D425, 0.4 g Pluronic P-105 and 0.3 g of Kelzan S were added to 257.3 g of the cyhalofop-butyl miniemulsion under low shear agitation and stirring was continued until the components were completely dissolved. 17.5 g of the 50% penoxsulam suspension was added to the miniemulsion under low shear agitation, followed by addition of 21.5 g water to produce the final suspoemulsion (suspominiemulsion) containing 214 g/l cyhalofop-butyl and 30 g/l penoxsulam.

### Referring Now to FIGS. 1-3

FIGS. 1, 2, and 3: The particle size distribution was measured using a Malvern Mastersizer 2000 laser diffraction particle sizer.

### Methods of Determining the Size of Particles or the Distribution of Particles in a Suspoemulsion

Microscopic determination of particle size can be used for typical suspoemulsions, but because the droplet size of the mini-emulsion is too small to see under the microscope, it's not really feasible for this composition.

Results of a stability test on the conventional suspoemulsion formed by combining the conventional cyhalofop-butyl emulsion with the suspension of penoxsulam show that after only four days after forming the conventional suspoemulsion and incubating it at 54° C. the conventional suspoemulsion separates into distinct phases. Unlike the inventive suspominiemulsion which is stable at 54° C. degrees for at least 14 days, the conventional suspoemulsion shows instability after only 4 days at the tested temperature. These results clearly show the robust and unexpectedly stable qualities of the inventive suspominiemulsion comprising a conventional suspension and a miniemulsion.

### Example 2

An oil-in-water fluoroxypyr-meptyl miniemulsion is prepared using the reagents and compounds listed in Table 2.

A suspension of florasulam is formed by wet-milling florasulam in an aqueous milieu that includes the reagents and compounds listed in Tablet.

The stable suspoemulsion is then created by mixing the fluoroxypyr-meptyl miniemulsion with the florasulam suspension in the presence of the additional reagents included in Table 2.

### Exemplary Methods for Forming Miniemulsions

191.2 g of Fluoroxypyr-meptyl were dissolved in a blend of 81.5 g Aromatic 100 S solvent, 159.2 g of C8-C10 DiMethyl Amide Solvent, 16 g of Ethocel 4, 20 g of Toximul 8323, 10 g of Tween 61 and 12 g of Nikkol DGMO. The oil phase was added to the aqueous phase consisting of 432.3 g water, 16.7 g Cedepal TD 403, 1 g Proxel GXL and 60 g propylene glycol under high shear agitation using a Silverson L4R laboratory homogenizer with a square hole high shear screen. Stirring was maintained for 3 minutes. The mixture was then introduced into a Nitro Soavi high pressure 2-stage homogenizer of the type Panda 2K, which is adjusted to a pressure of 800 bars for 2 successive passages.

A stabilized oil-in-water miniemulsion is thus obtained, the oily globules of which have a mean diameter d(0.5) of 118 nm.

### Exemplary Suspensions

The suspension containing 45% florasulam was prepared as per the following example. 45.0 g Florasulam was dispersed in an aqueous phase containing 43.62 g water, 1.8 g Darvan #1, 0.9 g Avicel CL611, 0.18 g Foamaster UDB, 0.2 g of orthophosphoric acid solution at 25%, 3.6 g Pluronic P-105 and 0.1 g Proxel GXL using a Silverson L4R laboratory homogenizer with a general purpose high shear screen. After the active ingredient was completely dispersed, the suspension was milled using an Eiger mill Model M250 filled at 80% capacity with 1.25-1.55 mm glass beads. Two passes through the mill were sufficient to achieve the desired particle size with a mean particle diameter d(0.5) of 1.5 μm and a d(0.9) of 12 μm max. After the milling process was completed, 0.1 g of Kelzan S dispersed in 4.5 g of water were added to the milled suspension under stirring and agitation was continued for 30 minutes.

### Exemplary Suspoemulsions (Suspominiemulsions)

0.25 g of water was added to 98.3 g of the fluoroxypyr-meptyl miniemulsion under low shear agitation, followed by addition of 1.45 g of the 45% florasulam suspension until the component were completely dispersed to produce the final suspominiemulsion containing 133.3 gae/1 fluoroxypyr and 6.67 g/l florasulam.

TABLE 2
Reagents and compounds used to create a stable exemplary
suspominiemulsion comprising a miniemulsion of fluroxypyr-
meptyl and a suspension of florasulam.

| | |
|---|---|
| | Aim Concen- |
| Role | tration (%) |

Miniemulsion Oil Phase

| | | |
|---|---|---|
| Fluroxypyr-meptyl | Active Ingredient | 19.12 |
| Aromatic 100 S | Solvent | 8.15 |
| C8-C10 Alkyldimethyl | Solvent | 15.92 |
| Amide Solvent | | |
| Ethocel C4 | Rheology Modifier | 1.6 |
| Toximul 8323 | Polymeric | 2.0 |
| | Surfactant | |
| | (HLB 17.0) | |
| Tween 61 | Nonionic | 1.0 |
| | Surfactant | |
| | (HLB 9.6) | |
| Nikkol DGMO | Nonionic | 1.2 |
| | Surfactant | |
| | (HLB 6.5) | |

Miniemulsion Aqueous Phase

| | | |
|---|---|---|
| Cedepol TD-403 | Anionic Surfactant | 1.67 |
| Proxel GXL | Biocide | 0.1 |
| Propylene Glycol | Antifreeze | 6.0 |
| Water | Continuous Phase | 43.24 |

Florasulam suspension

| | | |
|---|---|---|
| Florasulam | Active Ingredient | 45 |
| Darvan #1 | Dispersant | 1.8 |
| Avicel CL-611 | Rheology Modifier | 0.9 |
| Orthophosphoric acid (25%) | Acidifier | 0.2 |
| Kelzan | Rheology Modifier | 0.1 |
| Foamaster UDB | Antifoam | 0.18 |
| Propylene glycol | Antifreeze | 4.5 |
| Pluronic P-105 | Dispersant | 3.6 |
| Proxel GXL | Biocide | 0.1 |
| Water | Continuous Phase | 43.62 |

Suspoemulsion

| | |
|---|---|
| Cyhalofop-butyl | 98.3 |
| miniemulsion | |
| Florasulam suspension | 1.45 |
| Water | 0.25 |

TABLE 3
Stability data for exemplary fluroxypyr-
meptyl/florasulam suspominiemulsion

| Storage Conditions | d(0.5) | d(0.9) |
|---|---|---|
| Initial particle size measurement | 118 nm | 205 nm |
| 8 wks @ 40° C. storage | 120 nm | 212 nm |
| 2 wks freeze/thaw (−10/40° C.) | 120 nm | 210 nm |

While the novel technology has been illustrated and described in detail in the figures and foregoing description, the same is to be considered as illustrative and not restrictive in character, it being understood that only some of the embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

What is claimed is:

1. A formulation, comprising:
a suspoemulsion wherein the suspoemulsion includes;
an oil-in-water miniemulsion, wherein said miniemulsion includes at least one agriculturally active ingredient, the oil-in-water emulsion composition comprising:
A) an oil phase, wherein the oil phase includes at least one agriculturally active ingredient and is comprised essentially of oily globules, the oily globules having a mean particle diameter of less than about 800 nanometers; and
B) an aqueous phase, wherein the oily globules are dispersed in the aqueous phase and wherein at least some of the oily globules dispersed in the aqueous phase are coated with a polymeric adsorption layer, wherein said polymeric adsorption layer comprises:
(1) at least one polymeric surface-active agent having an HLB value in the range of about 16 to about 18; and
(2) at least one ionic surface-active agent, and
a suspension wherein the suspension includes at least one agriculturally active ingredient.

2. The formulation of claim 1, wherein the aqueous phase of said miniemulsion includes a second polymeric surface active agent having an HLB in the range of about 12 to about 14.

3. The formulation of claim 1, wherein the polymeric surface-active agent is selected from the group consisting of: amphipathic block and graft copolymers.

4. The formulation of claim 1, wherein the aqueous phase includes a non-ionic, non-polymeric surface active agent.

5. The formulation of claim 1, wherein the ionic surface-active agent is selected from the group consisting of: (a) neutralized anionic surface-active agents, (b) amphoteric surface-active agents, (c) alkylsulphonic derivatives and (d) cationic surface-active agents.

6. The formulation of claim 4, wherein the ionic surface-active agent is selected from the group consisting of: alkali metal salts of dicetyl phosphate and dimyristyl phosphate, in particular sodium and potassium salts; alkali metal salts of cholesteryl sulphate and cholesteryl phosphate, especially the sodium salts; lipoamino acids and their salts, such as mono- and disodium acylglutamates, such as the disodium salt of N-stearoyl-L-glutamic acid, the sodium salts of phosphatidic acid; phospholipids; the mono- and disodium salts of acylglutamic acids, in particular N-stearoylglutamic acid; and alkyl ether citrates.

7. The formulation of claim 4, wherein the ionic surface-active agent is a phospholipid.

8. The formulation of claim 4, wherein the ionic surface-active agent is an alkylsulphonic derivative.

9. The formulation of claim 4, wherein the ionic surface-active agent is selected from the group consisting of quaternary ammonium salts, fatty amines and salts thereof.

10. The formulation of claim 1, wherein the amount of the polymeric surface-active agents (1) in the composition is in the range of about 30 to about 95, wt. % of the total of both (1) and (2).

11. The formulation of claim 1, wherein the amount of the polymeric surface-active agents (1) in the composition is in the range of about 50 to about 95, weight percent of the total of both (1) and (2).

12. The formulation of claim 1, wherein the amount of the ionic surface active agent (2) in the composition is in the range of about 5 to about 50 wt. % of the total combined weight of (1) and (2).

13. The formulation of claim 1, wherein the amount of the ionic surface active agent (2) in the composition is in the range of about 10 to about 50 wt. % of the total combined weight of (1) and (2).

14. The formulation of claim 1, wherein the coating on the oily globules comprises between about 0.5 wt. % to about 20 wt. % based on the total weight of the oil-in-water emulsion.

15. The formulation of claim 1, wherein the coating on the oily globules comprises between about 0.5 wt. % to about 10 wt. % based on the total weight of the oil-in-water emulsion.

16. The formulation of claim 1, wherein the coating on the oily globules comprises between about 0.5 wt. % to about 2.5 wt. % based on the total weight of the oil-in-water emulsion.

17. The formulation of claim 1 wherein the agriculturally active ingredients are the herbicides cyhalofop-butyl and penoxsulam.

18. The formulation of claim 1 wherein the agriculturally active ingredients are the herbicides fluoroxypyr-meptyl and florasulam.

19. The formulation of claim 1, wherein the suspoemulsion includes at least two agriculturally active ingredients selected from the group consisting of: fungicides, insecticides, nematocides, miticides, biocides, termiticides, rodenticides, arthropodicides, herbicides, bactericides, and bacteria stats.

20. The formulation of claim 19, wherein the suspoemulsion includes at least one agriculturally active ingredient that is a herbicide.

21. The formulation of claim 20, wherein the herbicide is a sulfonamide herbicide selected from the group consisting of: flumetsulam, florasulam, penoxsulam, pyroxsulam, cloransulam-methyl, diclosulam and metosulam.

22. The formulation of claim 20, wherein the herbicide is selected from esters of 2,4-D, clopyralid, cyhalofop, dicamba, fluoroglycofen, fluoroxypyr, haloxyfop, MCPA and triclopyr.

23. A method of treating a plant, comprising the steps of providing a suspoemulsion according to claim 1.

24. A method of treating a plant, comprising the steps of: applying a suspoemulsion according to claim 1 to a surface.

25. The method according to claim 24, wherein the surface is the surface of a plant.

26. The method according to claim 24, wherein the surface is adjacent to a plant.

27. The method according to claim 24, wherein the surface is a surface of a plant pest or a plant pathogen.
